(19) United States
(12) Patent Application Publication
(10) Pub. No.: US 2026/0179040 A1
(43) Pub. Date: Jun. 25, 2026

(54) INFORMATION PROCESSING SYSTEM AND NON-TRANSITORY COMPUTER READABLE MEDIUM STORING PROGRAM

(71) Applicant: SUMITOMO HEAVY INDUSTRIES, LTD., Tokyo (JP)

(72) Inventors: Takuya KAWASHIMA, Chiba-shi (JP); Hiroshi MOGI, Chiba-shi (JP); Yousuke KOBUNA, Chiba-shi (JP); Takao NAKAYA, Chiba-shi (JP); Katsuki FUJITA, Chiba-shi (JP)

(21) Appl. No.: 19/308,652

(22) Filed: Aug. 25, 2025

(30) Foreign Application Priority Data
Dec. 23, 2024 (JP) 2024-226395

(51) Int. Cl. G06Q 10/087

(52) U.S. Cl. CPC G06Q 10/0877

(57) ABSTRACT

An information processing system includes: a machine information database that manages, for a machine configured by combining a plurality of units, in which the same type of part is selectively attached to at least some of different units, machine information including identification information for identifying at least an individual unit of the machine; and a part information database that manages part information in which, for the part attached to the machine, at least a name of the part and a part reference sign indicating a location of the machine to which the part is attached and a type of the part are associated with each other.

### CROSS-REFERENCE TO RELATED APPLICATIONS

This application claims priority to Japanese Patent Application No. 2024-226395, filed on Dec. 23, 2024, which is incorporated by reference herein in its entirety.

### BACKGROUND

### Technical Field

Certain embodiments of the present invention relate to an information processing system and a non-transitory computer readable medium storing a program.

### Description of Related Art

There is a system that manages machine part information. The related art discloses an information management system in which a control terminal device transmits a request signal indicating that part information is requested to a control server device, the control server device transmits server-specific information to a management server device in association with the request signal received from the control terminal device, and transmits the part information received from the management server device to the control terminal device, and the management server device holds part information (data structure in which at least one of part characteristics, work contents for handling parts, and part image data representing the part is associated with part-specific information) and management information (one data structure in which machine-specific information and the part-specific information are associated with the server-specific information), and retrieves the requested part information based on the received request signal and server-specific information to transmit the retrieved part information to the control server device.

### SUMMARY

According to an embodiment of the present invention, there is provided an information processing system including a machine information database that manages, for a machine configured by combining a plurality of units, in which the same type of part is selectively attached to at least some of different units, machine information including identification information for identifying at least an individual unit of the machine; and a part information database that manages part information in which, for the part attached to the machine, at least a name of the part and a part reference sign indicating a location of the machine to which the part is attached and a type of the part are associated with each other.

### BRIEF DESCRIPTION OF THE DRAWINGS

FIG. 1 is a diagram showing a configuration example of an information processing system according to the present embodiment.

FIG. 2 is a diagram showing a configuration of an injection molding machine.

FIG. 3 is a diagram showing a hardware configuration of an information processing device.

FIG. 4 is a diagram showing a hardware configuration of a management server.

FIGS. 5A and 5B are diagrams showing a database stored in a storage device of the management server, FIG. 5A is a diagram showing an example of a machine information database, and FIG. 5B is a diagram showing an example of a part information database.

FIG. 6 is a diagram showing an example of a display screen that displays a list of target devices owned by users.

FIG. 7 is a diagram showing an example of a display screen for displaying information of a target device.

FIG. 8 is a diagram showing an example of an order screen for ordering parts.

### DETAILED DESCRIPTION

In general, a part of a machine or the like is managed by using a part name or a part number capable of specifying the type of the part. Meanwhile, a user of the machine often recognizes individual parts by where the parts are used in the machine rather than by information such as the part number. Here, there is a machine in which a plurality of units are configured in combination and the same type of part is selectively used for at least some of different units. In the case of specifying a part to be acquired as needed, such as part replacement, in such a machine, an effort is required for the specification of the part.

It is desirable to reduce the effort required for specifying a part in a machine in which a plurality of units are configured in combination and the same type of part is selectively used for at least some of different units.

Hereinafter, an embodiment of the present invention will be described in detail with reference to the accompanying drawings.

### System Configuration

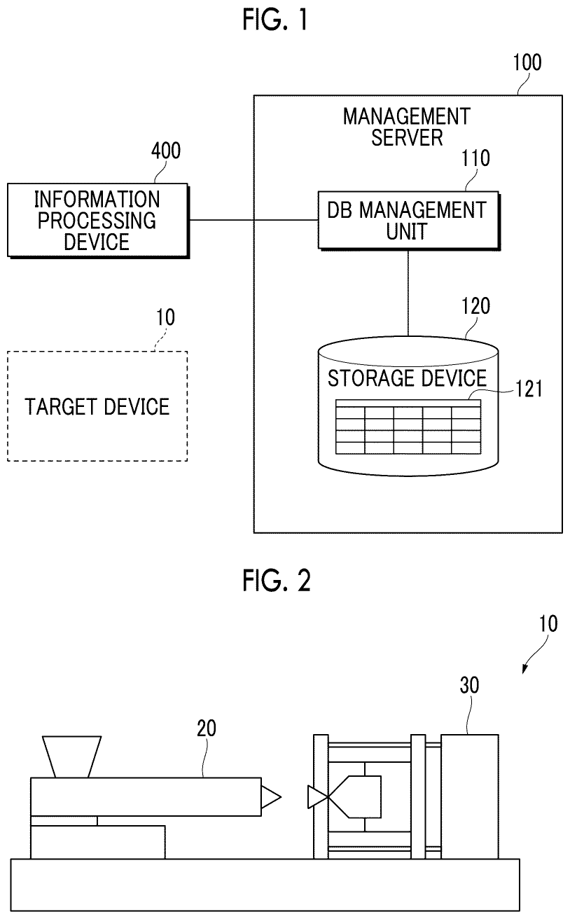

FIG. 1 is a diagram showing a configuration example of an information processing system according to the present embodiment. The information processing system includes a management server 100 and an information processing device 400. The information processing system is a management system that manages a target device 10, which is a machine to be managed, and a part attached to the target device 10.

The management server 100 includes a database (DB) management unit 110 and a storage device 120. A database 121 is stored in the storage device 120. The DB management unit 110 accesses the storage device 120 and executes processes such as registration, retrieval, or editing of data to the database 121. The management server 100 may be a single server machine or may be a virtual server (for example, a cloud server) constructed using resources on a network.

The information processing device 400 is a device for a user to browse information stored in the database 121 of the management server 100. The information processing device 400 is realized by, for example, a computer device such as a personal computer. The information processing device 400 is connected to the management server 100 via the network. The user operates the information processing device 400 to access the database 121 of the management server 100 and acquire information. The functions of the information processing device 400, the interfaces used to acquire information by the information processing device 400, and the like will be described below.

The target device 10 is a mechanical device in which a plurality of units are configured in combination and the same type of part is selectively attached to at least some of different units. The type of the device is not limited as long as the device has such a configuration. A specific example of such a device is an injection molding machine. Hereinafter, a case where the present embodiment is applied to the parts management of the injection molding machine will be described as an example. In the following description, reference sign 10 of the target device 10 will be assigned to the injection molding machine.

### Configuration Example of Target Device 10

FIG. 2 is a diagram showing a configuration of the injection molding machine 10. The injection molding machine 10 is an example of the target device 10. The injection molding machine 10 includes an injection device 20 and a mold clamping device 30. In addition, although not shown in FIG. 2, the injection molding machine 10 is provided with a control device for controlling the operations of the injection device 20 and the mold clamping device 30, a data processing device for processing data obtained in an injection molding process, and the like. The injection device 20 is one of the units of the injection molding machine 10 as the target device. In addition, the mold clamping device 30 is one of the units of the injection molding machine 10 as the target device.

The injection device 20 is configured to include a cylinder that heats a molding material, a screw that is provided to be rotatable in the cylinder and be able to advance and retreat in an axial direction, a rotary motor that drives the screw in a rotational direction, a motor that drives the screw in the axial direction, and the like. The molding material is, for example, a resin. The injection device 20 injects the molding material heated and liquefied in the cylinder by advancing in a direction (forward) toward the mold clamping device 30 from the injection device 20 while rotating the screw, and fills a mold of the mold clamping device 30 disposed in front of the injection device 20.

The mold clamping device 30 is configured to include the mold, a clamping mechanism that clamps the mold, a motor that drives the clamping mechanism, and the like. The mold clamping device 30 closes the mold to receive the molding material injected from the injection device 20 into the mold. In this case, the mold clamping device 30 clamps the mold by using the clamping mechanism such that the mold is prevented from being opened due to the filling of the molding material (mold clamping). A molding product is produced by solidifying the molding material filled in the mold. After this, the mold clamping device 30 opens the mold, allowing the produced molding product to be removed.

### Unit Configuration of Injection Molding Machine 10

The injection molding machine 10 as the target device is configured by combining the injection device 20 and the mold clamping device 30 as units. In addition, although not specifically shown, the injection device 20 can be identified as being configured by combining units such as a hopper, a cylinder, and a nozzle. These units can be identified as being further divided into smaller constituent units. In addition, the mold clamping device 30 can be identified as being configured by combining units such as a mold clamping cylinder, a stationary-side die plate, and a movable-side die plate. These units can be identified as being further divided into smaller constituent units.

Various parts are provided in these units. Examples of the parts provided in the units include members constituting the units, a screw for fixing the units to each other, and a motor for operating a movable part. As a relationship between the units and the parts, the same type of part may be used for different units. For example, the injection device 20 is provided with a screw for carrying the molding material in the cylinder to a tip of the cylinder, and a motor for rotating the screw is provided. Meanwhile, the mold clamping device 30 is provided a toggle mechanism that moves the movable-side die plate to generate a mold clamping force, and a motor for operating the toggle mechanism. When the conditions such as the required output are the same, the same type of motor may be used as these motors. In addition, the same type of screw can also be used for the screw for fixing the members or the units depending on the section used.

Normally, in a database that manages the target device 10 such as the injection molding machine 10, for example, type information of the target device 10, part information for specifying a part used in the target device 10, and the like are managed as information of the target device 10 (for example, machine master information). The type information of the target device 10 is used to specify the type of the target device 10. The part information includes, for example, information that can identify each part, such as a part number (part number) and a model number. In addition, the name of the part is also included in the part information.

In the part information, the part is specified according to the type of the part as a product. Therefore, in the case of the same type of part, the same part number, model number, part name, and the like are used even when the part is used in any section of the target device 10. Meanwhile, since a 50-t machine (injection molding machine 10 capable of applying a mold clamping force of up to 50 tons) and a 100-t machine (injection molding machine 10 capable of applying a mold clamping force of up to 100 tons) have different apparatus sizes, even the same type of parts used in the same section may have different products and different part numbers.

Due to these circumstances, in a case where a customer of the target device 10 orders a part for replacing a consumable, an effort is required for the specification of the target part between the customer and a customer support staff person, which is troublesome. In the present embodiment, a specific reference sign (part reference sign) is attached to the part to easily specify the part in the target device 10. Details of the part reference sign will be described below.

### Configuration of Information Processing Device 400

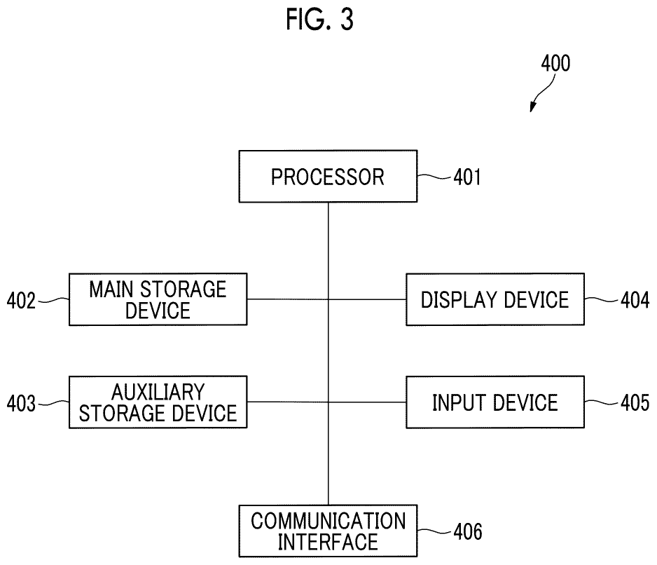

FIG. 3 is a diagram showing a hardware configuration of the information processing device 400. The information processing device 400 is realized by a computer. The computer constituting the information processing device 400 includes a processor 401 as calculation unit, and a main storage device (main memory) 402 and an auxiliary storage device 403 as a storage unit. For example, as the processor 401, a central processing unit (CPU), a graphics processing unit (GPU), an application-specific integrated circuit (ASIC), a field-programmable gate array (FPGA), or other various calculation circuits can be used. The processor 401 reads a program stored in the auxiliary storage device 403 into the main storage device 402 to execute the program. For example, a random-access memory (RAM) is used as the main storage device 402. For example, a magnetic disk device, a solid-state drive (SSD), or the like is used as the auxiliary storage device 403.

In addition, the computer constituting the information processing device 400 includes a display device 404 for displaying an image and an input device 405 as an input unit for an input operation performed by a user of the computer. For example, a keyboard, a mouse, a touch panel, or the like is used as the input device 405. In a case where a touch panel configured integrally with the display device 404 is used as the input device 405, the user performs an input operation by touching an operation screen displayed on the display device 404 with his/her finger or a pen-type device.

In addition, the computer constituting the information processing device 400 includes a communication interface 406 for connecting to the network and communicating with the management server 100. As for the communication, a specific method or specification is not particularly limited as long as communication with the management server 100 is possible. In addition, the network is not particularly limited as long as a communication network used for data communication between the devices is provided, and may be, for example, a local area network (LAN), a wide area network (WAN), the Internet, or the like. As communication lines used for the data communication, wired or wireless communication lines may be used together. In addition, a relay device such as a gateway device or a router may be configured to connect the devices to each other via a plurality of networks or communication lines.

In a case where the information processing device 400 is realized by the computer shown in FIG. 3, reception of user's operations, communication with the management server 100, display of images on the display device 404, and other various information processing are executed, for example, by the processor 401 executing a program. In addition, the configuration of the computer shown in FIG. 3 is merely an example, and the computer constituting the information processing device 400 is not limited to the configuration example of FIG. 3.

### Configuration of Management Server 100

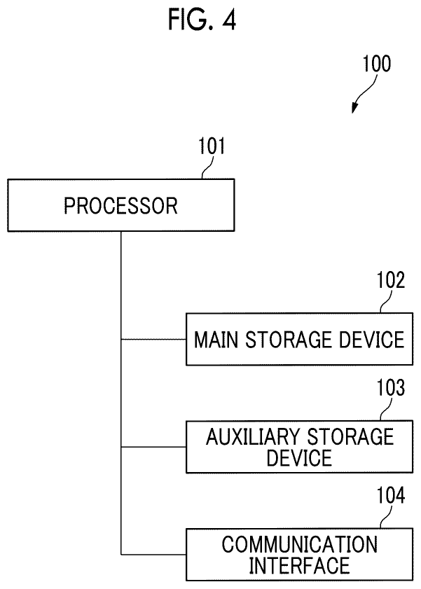

FIG. 4 is a diagram showing a hardware configuration of the management server 100. The management server 100 is realized by a computer. The computer constituting the management server 100 includes a processor 101 as a calculation unit, and a main storage device (main memory) 102 and an auxiliary storage device 103 as a storage unit. For example, as the processor 101, a central processing unit (CPU), a graphics processing unit (GPU), an application-specific integrated circuit (ASIC), a field-programmable gate array (FPGA), or other various calculation circuits can be used. The processor 101 reads a program stored in the auxiliary storage device 103 into the main storage device 102 to execute the program. For example, a random-access memory (RAM) is used as the main storage device 102. For example, a magnetic disk device, a solid-state drive (SSD), or the like is used as the auxiliary storage device 103.

In addition, the computer constituting the management server 100 includes a communication interface 104 for connecting to the network and communicating with the information processing device 400. As for the communication, a specific method or specification is not particularly limited as long as communication with the information processing device 400 is possible.

In a case where the management server 100 is realized by the computer shown in FIG. 4, a DB management unit 110 (refer to FIG. 1) is realized, for example, by the processor 101 executing a program. Various information processing such as communication with the information processing device 400 is executed, for example, by the processor 101 executing a program. In addition, the storage device 120 (refer to FIG. 1) is realized by, for example, the auxiliary storage device 103. In addition, the configuration of the computer shown in FIG. 4 is merely an example, and the computer constituting the management server 100 is not limited to the configuration example shown in FIG. 4.

### Configuration of Database 121

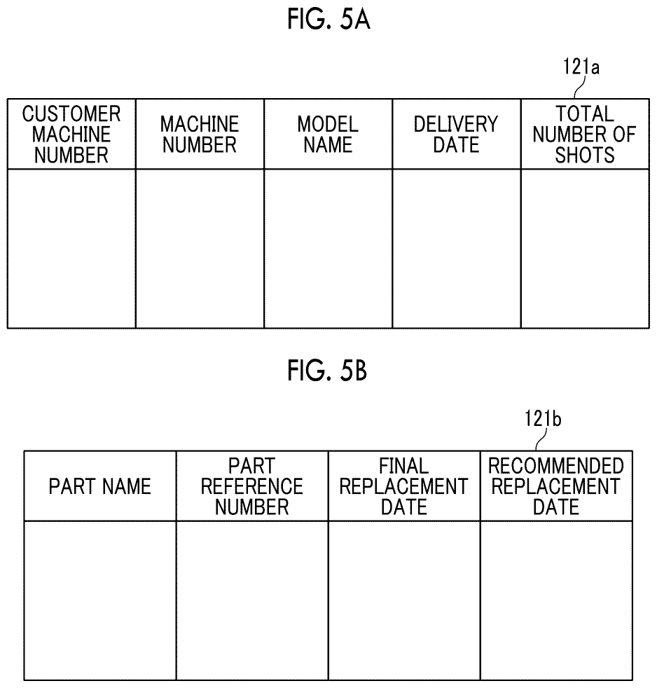

FIGS. 5A and 5B are diagrams showing a database 121 stored in the storage device 120 of the management server 100. FIG. 5A is a diagram showing an example of a machine information database, and FIG. 5B is a diagram showing an example of a part information database.

As described with reference to FIG. 1, the management server 100 stores the database 121 in the storage device 120. The management server 100 has, as the database 121, at least a machine information database 121a for managing the target device 10 and a part information database 121b for managing parts provided in the target device 10.

The machine information database 121a holds identification information for identifying an individual unit of the target device 10 in association with information related to the individual unit. In the example shown in FIG. 5A, in the machine information database 121a, information (machine information) of respective items of “customer machine number”, “machine number”, “model name”, “delivery date”, and “total number of shots” is registered for each individual unit of the target device 10. Here, a case where the target device 10 is the injection molding machine 10 will be described as an example. The “customer machine number” is an identification number of the individual unit of the target device 10 for a customer. The “machine number” is an identification number of the individual unit of the target device 10. The “model name” is a name corresponding to the model of the target device 10. The “delivery date” is a date on which the target device 10 was delivered to the customer. The “total number of shots” is the total number of shots performed in the injection molding machine 10 which is the target device 10. Here, the “customer machine number” and the “machine number” can be used as identification information for identifying the individual unit of the target device 10. The “model name”, the “delivery date”, and the “total number of shots” can be identified as information associated with the identification information.

The part information database 121b associates part names with part reference signs and holds information related to the parts in association with each other. In the example shown in FIG. 5B, in the part information database 121b, information (part information) of respective items of “part name”, “part reference sign”, “final replacement date”, and “recommended replacement date”, is registered for each part. The “part name” is the name of the corresponding part. The “part reference sign” is a reference sign assigned to the corresponding part. The “final replacement date” is a date on which the corresponding part was attached to the target device 10 by the last part replacement. The “recommended replacement date” is a date on which the replacement was recommended based on the final replacement date of the corresponding part and the part life.

The “part reference sign” will be further described. The part reference sign is a reference sign configured to include information indicating a location where a corresponding part is attached to the target device 10 and information indicating the type of the corresponding part. Various information can be used as the information indicating the location in the target device 10 as long as the information is capable of specifying the location where the part is attached. For example, information for specifying a unit to which the part is attached may be used as the information indicating the location.

As an example, a part reference sign of an injection ball screw provided in the injection molding machine 10 as the target device 10 is considered. The injection ball screw is a ball screw provided in the injection device 20 that is a unit constituting the injection molding machine 10. Therefore, the part reference sign is a reference sign including information indicating the injection device 20 that is a location where the injection ball screw is provided and information indicating the ball screw. For example, the part reference sign of the injection ball screw may be “11AB” or the like by using reference sign “11” as the information indicating the injection device 20 as a unit, and using reference sign “AB” as the information indicating the ball screw.

The part reference sign includes the information indicating a location where the part is attached and the information indicating the type of the corresponding part. Therefore, the part reference signs of the same parts attached to the same location are the same, but the part reference signs of the same parts attached to different locations are different from each other. For example, a case is considered where a ball screw (reference sign “11AB”) identical to the above injection ball screw is provided, and the ball screw is attached to the mold clamping device 30. In this case, when the reference sign of the mold clamping device 30 is set to “21”, the part reference sign of the ball screw attached to the mold clamping device 30 is “21AB”, which is a reference sign different from that of the above injection ball screw “11AB”.

Meanwhile, even when the models of the target devices 10 are different, the part reference signs of the same parts attached to the same location are the same. For example, it is described that even the same type of parts used in the same section may have different part numbers between the 50-t machine and the 100-t machine. In contrast, in the case of the part reference sign, the ball screw (reference sign “AB”) attached to the injection device 20 (reference sign “11”) is the same part reference sign “11AB” in any of the target devices 10. Therefore, when the model can be specified, the location of the target device 10 and the type of the part can be specified by the part reference sign. For this reason, in a situation where the customer of the target device 10 orders a part for replacement of a consumable, the part in the target device 10 can be easily specified between the customer and the customer support staff person.

In addition, the unit of the target device 10 may be hierarchically configured. For example, it is described that the injection device 20 as a unit in the injection molding machine 10 can be identified as being configured by combining units such as a hopper, a cylinder, and a nozzle. In this case, the injection device 20 can be hierarchically identified as a higher-level unit and a hopper, a cylinder, a nozzle, and the like as lower-level units. In this case, the reference sign indicating the location among the part reference signs may be configured to correspond to the hierarchical structure of the units. For example, in the above example, in the part reference sign “11AB” of the injection ball screw, the reference sign indicating the injection device 20, which is a location, is “11”. Here, for example, a reference sign indicating a hopper is “1”, a reference sign indicating a cylinder is “2”, a reference sign indicating a nozzle is “3”, and a reference sign indicating a screw commonly used in these units is “CD”. In a case where the location of a lower-level unit is specified, a reference sign indicating the location of the lower-level unit is added to a reference sign indicating the location of a higher-level unit. In this case, the part reference sign of a screw attached to the hopper of the injection device 20 is “111CD”, the part reference sign of a screw attached to the cylinder is “112CD”, and the part reference sign of a screw attached to the nozzle is “113CD”.

### Usage Example of Database

A usage example of the machine information database 121a and the part information database 121b held in the management server 100 will be described. The above part reference sign is registered in the part information database 121b for the part. Hereinafter, an example in which the information processing device 400 accesses the management server 100 to acquire the information of the part and executes the order processing of the part to be replenished will be described as the usage example of the above machine information database 121a and part information database 121b. In the following example, the user of the information processing device 400 is assumed to be the customer of the target device 10.

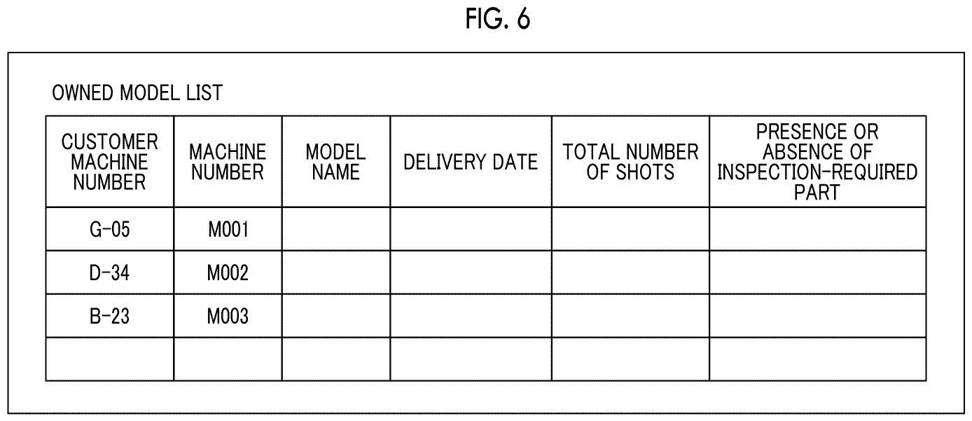

FIGS. 6 to 8 are examples of screens displayed on the display device 404 of the information processing device 400. A user performs an operation based on a screen displayed on the display device 404 of the information processing device 400, and performs order processing by designating a desired part of a specific target device 10 among the target devices 10 owned by users who are customers.

FIG. 6 is a diagram showing an example of a display screen that displays a list of the target devices 10 owned by the users. The information processing device 400 holds a machine information database related to the target devices 10 owned by the user. The machine information database held in the information processing device 400 is an example of a user machine information database. The machine information database records information on the respective items of “customer machine number”, “machine number”, “model name”, “delivery date”, “total number of shots”, and “presence or absence of inspection-required part” with respect to the target devices 10 owned by the user. These pieces of information are examples of the user machine information. The respective items of “customer machine number”, “machine number”, “model name”, “delivery date”, and “total number of shots” are the same as the corresponding items of the machine information database 121a described with reference to FIG. 5. The “presence or absence of the inspection-required part” is information indicating the presence or absence of a part that satisfies a predetermined condition and that is determined to require inspection, among the parts provided in the target device 10. For example, consumables having a set part life, which are parts or the like for which the number of days elapsed after being attached to the target device 10 is close to the part life, can be given.

The information processing device 400 reads the information of each target device from the machine information database related to the target devices 10 owned by the user and displays the information on the display device 404 as a list screen as shown in FIG. 6. The list screen also functions as an operation screen that receives an operation for acquiring information of the target device 10 from the management server 100. The user selects any one of the target devices 10 shown on the displayed list screen, and performs an instruction for displaying information. Specifically, for example, the instruction for displaying information related to the selected target device 10 is performed by an operation of clicking the customer machine number of the desired target device 10 among target devices 10 shown on the list screen shown in FIG. 6 with a mouse. When the instruction for displaying information is performed, the information processing device 400 transmits a request (query) for the information of the target device 10 to the management server 100 together with the identification information of the selected target device 10.

When the request is received, the management server 100 reads the information of the corresponding target device 10 from the database 121. Specifically, the management server 100 reads the machine information of the corresponding target device 10 from the machine information database 121a, based on the identification information of the target device 10 included in the received request. Then, the management server 100 reads the part information of the target device 10 specified based on the read machine information from the part information database 121b. In addition, the management server 100 acquires other information, in the case of any, related to the specified target device 10. Then, the management server 100 transmits the obtained information related to the target device 10 to the information processing device 400. The information processing device 400 displays the information of the target device 10 received from the management server 100 on the display device 404.

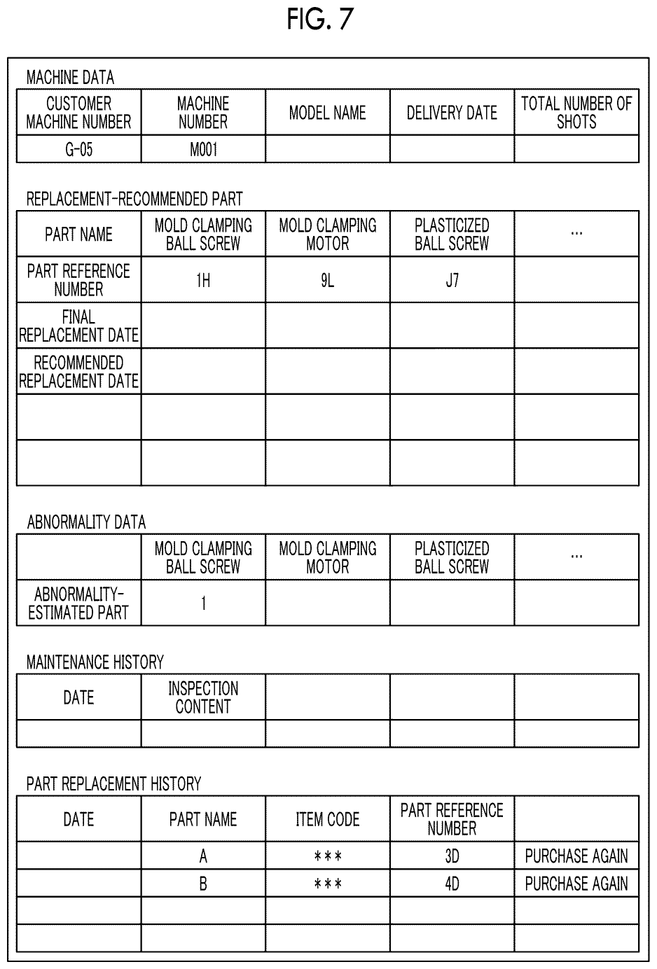

FIG. 7 is a diagram showing an example of a display screen that displays the information of the target device 10. On the display screen shown in FIG. 7, five tables are displayed: “machine data”, “replacement-recommended part”, “abnormality data”, “maintenance history”, and “part replacement history”. In addition, the table shown in FIG. 7 is merely an example of the information of the target device 10 acquired from and displayed by the management server 100. The displayed information may be part of the information shown in FIG. 7, or information of the target device 10 not shown in FIG. 7 may be displayed.

In the example shown in FIG. 7, the machine information of the target device 10 designated on the screen of FIG. 6 is displayed in the “machine data” table. In the “machine data” table shown in FIG. 7, information of the respective items of “customer machine number”, “machine number”, “model name”, “delivery date”, and “total number of shots” is displayed. Each of these items is the same as the corresponding item of the machine information database 121a described with reference to FIG. 5A. In the example shown in FIG. 7, the machine information of the target device 10 having a customer machine number “G-05” and a machine number “M001” is displayed in the “machine data” table.

In the example shown in FIG. 7, the part information of a part that is recommended to be replaced in the target device 10 shown in the “machine data” table is displayed in the “replacement-recommended part” table. In the table of the “replacement-recommended part” shown in FIG. 7, information of the respective items of “part name”, “part reference sign”, “final replacement date”, and “recommended replacement date” is displayed. Each of these items is the same as the corresponding item of the part information database 121b described with reference to FIG. 5B. In the example shown in FIG. 7, the part information related to three types of parts, which are a part name “mold clamping ball screw” (part reference sign 1H), a part name “mold clamping motor” (part reference sign 9L), and a part name “plasticized ball screw” (part reference sign J7), is displayed as replacement-recommended part.

In the example shown in FIG. 7, the “abnormality data” table displays information of the part for which the abnormality is estimated in the target device 10 shown in the “machine data” table. The estimation of the abnormality is performed, for example, based on an event such as the abnormality being detected in a sensor that acquires information indicating the state of the part. The “abnormality data” table shown in FIG. 7 shows the parts shown in the “replacement-recommended part” table. It is also shown that one part for which the abnormality is estimated is present with respect to the “mold clamping ball screw”.

In the example shown in FIG. 7, history information of maintenance work performed on the target device 10 shown in the “machine data” table is displayed in the “maintenance history” table. In the “maintenance history” table shown in FIG. 7, information of respective items of “date” and “inspection content” is displayed. The “date” is a date on which the maintenance work was performed. The “inspection content” is the content that is carried out in the maintenance work.

In the example shown in FIG. 7, the “part replacement history” table displays information related to the replacement history of a part (for example, a consumable) to be replaced with respect to the target device 10 shown in the “machine data” table. In the “part replacement history” table shown in FIG. 7, information of respective items of “date”, “part name”, “item code”, and “part reference sign” is displayed. The “date” is the date on which the corresponding part was replaced. The “part name” is the name of the corresponding part. The “item code” is code information for identifying the corresponding part in a part manufacturer. The “part reference sign” is a part number attached to the corresponding part. In addition, the “part replacement history” table shown in FIG. 7 is provided with a field in which “purchase again” is written for the record of each part. This field is an operation item for selecting whether or not the part is to be ordered. The part on which a selection operation is performed in the “purchase again” field is to be ordered, and is displayed on the order screen.

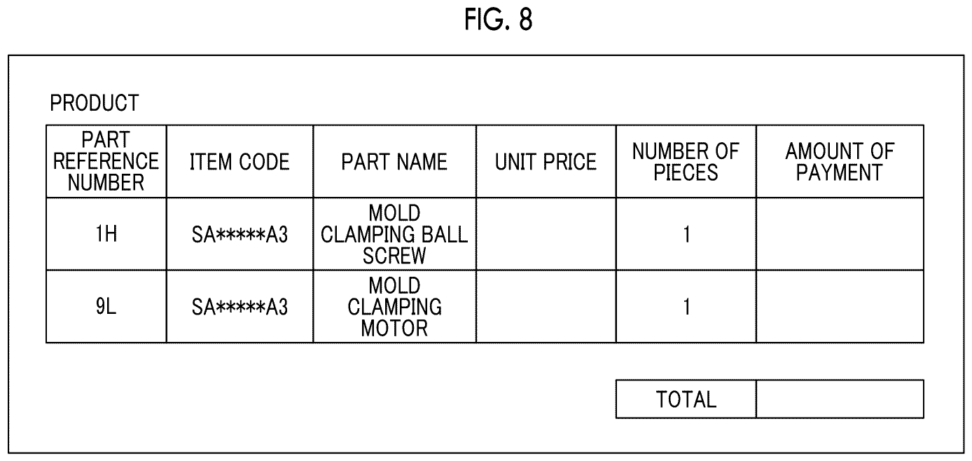

FIG. 8 is a diagram showing an example of an order screen for ordering parts. The order screen displays a “product” table and a total amount display field in which “total” is written. In the “product” table, information of respective items of “part reference sign”, “item code”, “part name”, “unit price”, “number of pieces”, and “amount of payment” is displayed. The “part reference sign” is the part reference sign of the part to be ordered. The “item code” is the item code of the part to be ordered. The “part name” is the part name of the part to be ordered. The “unit price” is the unit price of the part to be ordered. The “number of pieces” is the number of parts to be ordered. The “amount of payment” is an amount (unit price×number of pieces) for each part to be ordered. In the example shown in FIG. 8, one mold clamping ball screw (part reference sign 1H) and one mold clamping motor (part reference sign 9L) are displayed as parts to be ordered. A total amount of payment of all the parts to be ordered is displayed in the total amount display field.

The user designates one target device 10 on the list screen of the target devices 10 shown in FIG. 6. Then, the user specifies a part, which is an order target, with reference to the screen of FIG. 7 displayed based on the information acquired from the management server 100. In this case, in the “replacement-recommended part” table or the “part replacement history” table, a part reference sign is written for each part. Therefore, the user can specify the part to be ordered, by the intuitive recognition of which part is provided at which location of the target device 10.

In the above application example, an example of ordering the part is described by assuming that the user of the information processing device 400 is a customer who owns the target device 10. In contrast, even in a case where the part is ordered via the customer support staff person, the part to be ordered can be specified by the intuitive recognition of which part is provided at which location of the target device 10. Therefore, the complexity of the work of the customer support staff person can be reduced.

In addition, in the above application example, it is assumed that the information processing device 400 holds the machine information database related to the target device 10 owned by the customer. In contrast, the management server 100 may hold a database of customer information, may add information of the customer of the target device 10 to the machine information database 121a, and may associate the customer with the machine information of the target device 10. In this way, the information processing device 400 transmits customer's authentication information to the management server 100, so that the management server 100 can specify the target device 10 held by the customer and return the machine information. The information processing device 400 can generate and display a list of the target devices 10 held by customers as shown in FIG. 6, based on the information acquired from the management server 100.

Although the embodiments of the present invention have been described above, the technical scope of the present invention is not limited to the above-described embodiments. In the above embodiment, an application example in which a situation where the user who is a customer specifies and orders the part of the target device 10 is assumed has been shown. However, the application target of the present embodiment is not limited to the ordering of the part. The present embodiment is applicable to various situations where the specification of the part in the target device 10 configured by combining the units is required. In addition, various modifications and alternative configurations that do not depart from the scope of the technical thought of the present invention are included in the present invention.

It should be understood that the invention is not limited to the above-described embodiment, but may be modified into various forms on the basis of the spirit of the invention. Additionally, the modifications are included in the scope of the invention.

What is claimed is:

1. An information processing system comprising:
a machine information database that manages, for a machine configured by combining a plurality of units, in which the same type of part is selectively attached to at least some of different units, machine information including identification information for identifying at least an individual unit of the machine; and
a part information database that manages part information in which, for the part attached to the machine, at least a name of the part and a part reference sign indicating a location of the machine to which the part is attached and a type of the part are associated with each other.

2. The information processing system according to claim 1,
wherein the machine information database and the part information database are provided in a management server.

3. The information processing system according to claim 2,
wherein the management server includes a storage device in which a database including at least the machine information database and the part information database is stored, and a database management unit that accesses the storage device and executes data processing on the database.

4. The information processing system according to claim 3, further comprising:
an information processing device connected to the management server via a network.

5. The information processing system according to claim 4,
wherein the information processing device includes a display device that displays an operation screen on which a user performs an input operation.

6. The information processing system according to claim 1,
wherein the machine is an injection molding machine.

7. The information processing system according to claim 1,
wherein the part reference sign managed in the part information database is a reference sign configured by combining a first reference sign indicating the location of the machine to which the part is attached and a second reference sign indicating the type of the part.

8. The information processing system according to claim 7,
wherein the first reference sign in the part reference sign is a reference sign for specifying a unit constituting the machine.

9. The information processing system according to claim 8,
wherein the machine is configured such that the units are hierarchically configured in combination, and
the first reference sign in the part reference sign is a reference sign identifiable as indicating a hierarchical level of the unit.

10. The information processing system according to claim 1, further comprising:
a user machine information database that manages, for each user, user machine information including the identification information, for the machine associated with each user,
wherein the machine information database specifies and outputs the machine information of the machine specified by the identification information, in response to a query performed by specifying the identification information included in the user machine information managed in the user machine information database, and
the part information database specifies and outputs the part information of the part attached to the machine specified by the identification information included in the machine information output in the machine information database.

11. The information processing system according to claim 1, further comprising:
an operation reception unit that presents the part information output from the part information database to a user and receiving a designation operation of a part by the user; and
an ordering unit that orders the part designated by the designation operation of the user.

12. A non-transitory computer readable medium storing a program, the program when executed by a processor, causing the processor to:
manage machine information, for a machine configured by combining a plurality of units, in which the same type of part is selectively attachable to at least some of different units, the machine information including identification information for identifying at least an individual unit of the machine; and
manage part information in which, for the part attached to the machine, at least a name of the part and a part reference sign indicating a location of the machine to which the part is attached and a type of the part are associated with each other.
